(19) United States
(12) Patent Application Publication
(10) Pub. No.: US 2005/0165613 A1
(43) Pub. Date: Jul. 28, 2005

(54) Methods for constructing multimedia database and providing mutimedia-search service and apparatus therefor

(76) Inventor: Chung Tae Kim, Sungnam-city (KR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/506,600

(22) PCT Filed: Mar. 6, 2003
(86) PCT No.: PCT/KR03/00437

(30) Foreign Application Priority Data
Mar. 6, 2002 (KR) 10-2002-0011866

(51) Int. Cl. G06F 17/60

(52) U.S. Cl. 705/1

(57) ABSTRACT

Provided are a method and a system for constructing a multimedia database by indexing multimedia data, and a method and a system for providing a multimedia data search service using a multimedia database. (Claim) Accordingly, it is possible to quickly and precisely search for desired data.

### TECHNICAL FIELD

The present invention relates to a method and a system for constructing a multimedia database for indexing multimedia data, and a method and a system for providing a search service using the multimedia database.

### BACKGROUND ART

In accordance with the increase in the storage capacity of computers, the wide use of the Internet, and the spread of high-speed communication networks, great attention has been paid to multimedia content including a moving picture and voice data having a large file size.

Accordingly, many search service providers, who used to be capable of providing only text as search results, have started to provide search services for multimedia data to consumers.

According to a conventional multimedia content search service, each multimedia file is stored in a multimedia database, and the multimedia database is generally constructed by using an entity-relationship model for developing a relationship-oriented database or an object-oriented analysis and a design model for developing an object-oriented database. Accordingly, when a user types in a keyword for multimedia data that he or she wants to search for, a multimedia file corresponding to the typed-in keyword is drawn from the multimedia database and presented to the user.

However, if a plurality of multimedia files are obtained as search results, the user has no option but to execute all the multimedia files in order to find, among the multimedia files, a multimedia data file that the user has been looking for. Therefore, the conventional multimedia content search service costs the user a considerable amount of time and great effort.

### DISCLOSURE OF THE INVENTION

Accordingly, the present invention provides a method of constructing a multimedia database.

The present invention also provides a system for constructing a multimedia database.

The present invention also provides a method of providing a multimedia data search service.

The present invention also provides a system for providing a multimedia data search service.

The present invention also provides a method of purchasing multimedia content.

The present invention also provides a system for purchasing multimedia content.

According to an aspect of the present invention, there is provided a method of constructing a multimedia database method. The method includes (a) receiving a start point and an end point of each first semantic unit of multimedia data, which is a smallest unit for searching for multimedia data, (b) receiving a keyword for each first semantic unit, (c) receiving a start point and an end point of each second semantic unit of the multimedia data including at least one first semantic unit, and (d) storing a keyword together with location information of its corresponding first semantic unit and second semantic unit.

According to another aspect of the present invention, there is provided a system for constructing a multimedia database. The system includes a multimedia database which stores multimedia data, a keyword database which stores keywords necessary for searching for the multimedia data, location information of each first semantic unit of the multimedia data, which is a smallest unit for searching for multimedia data, and location information of each second semantic unit of the multimedia data, which includes at least one first semantic unit, an input unit which receives the location information of each first semantic unit, including a start point and an end point, the location information of each second semantic unit, including a start point and an end point, and the keywords, and a control unit which receives the location information of each first semantic unit, the location information of each second semantic unit, and the keywords from the input unit and stores the keywords in the keyword database together with their corresponding first and second semantic units' location information.

According to another aspect of the present invention, there is provided a method of constructing a multimedia database. The method includes (a) setting a length of each first semantic unit of multimedia data, which is a smallest unit for searching for multimedia data according to a user's input, (b) extracting a keyword from each first semantic unit using a predetermined method, (c) setting a length of each second semantic unit of the multimedia data including at least one first semantic unit according to the users input, and (d) storing the extracted keyword with its corresponding first semantic unit and second semantic unit.

According to another aspect of the present invention, there is provided a system for constructing a multimedia database. The system includes a multimedia database which stores multimedia data, a keyword database which stores keywords necessary for searching for the multimedia data, location information of each first semantic unit of the multimedia data, which is a smallest unit for searching for multimedia data, and location information of each second semantic unit of the multimedia data, which includes at least one first semantic unit, a keyword extraction unit which extracts keywords from the multimedia data using a predetermined method, and a control unit which divides the multimedia data into first semantic units and second semantic units and stores keywords in the keyword database together with their corresponding first and second semantic units' location information.

According to another aspect of the present invention, there is provided a method of providing a multimedia data search service using a system for providing a multimedia data search service, including a multimedia database which stores multimedia data, and a keyword database which stores keywords necessary for searching for the multimedia data, location information of each first semantic unit of the multimedia data, which is a smallest unit for searching for multimedia data, and location information of each second semantic unit of the multimedia data, including at least one first semantic unit. The method includes (a) receiving keywords necessary to search for multimedia data, (b) allowing a user to select a search unit level from between a first semantic unit and a second semantic unit, (c) searching for multimedia data of the received search unit level whose keywords match the received keyword, and (d) outputting information of a searched semantic unit of the received search unit level, linking with the search semantic unit in the multimedia database.

According to another aspect of the present invention, there is provided a system for providing a multimedia data search service. The system includes a multimedia database which stores multimedia database, a keyword database which stores keywords necessary for searching for the multimedia data, location information of each first semantic unit of the multimedia data, which is a smallest unit for searching for multimedia data, and location information of each second semantic unit of the multimedia data, which includes at least one first semantic unit, an input unit which receives a keyword and a search unit level a user, a control unit which searches the keyword database for a keyword that matches the received keyword, provides links between resulting search results and places in the multimedia database where the search results are stored, and outputs some of the search results selected by the user and a display unit which displays the searched results obtained by the control unit.

According to another aspect of the present invention, there is provided a method of constructing a multimedia database. The method includes (a) receiving location information of each semantic unit of multimedia data, which is a smallest unit for searching for multimedia data, (b) receiving a keyword for each semantic unit, and (c) storing keywords together with their corresponding semantic unit location information.

According to another aspect of the present invention, there is provided a system for constructing a multimedia database. The system includes a multimedia database which stores multimedia data, a keyword database which stores keywords necessary for searching for the multimedia data and location information of each semantic unit, which is a smallest unit for searching for multimedia data, an input unit which receives the location information of each semantic unit, including a start point and an end point, and the keywords, and a control unit which receives the location information of each semantic unit from the input unit and the keywords and stores the keywords in the keyword database together with their corresponding semantic unit's location information.

According to another aspect of the present invention, there is provided a method of constructing a multimedia database. The method includes (a) receiving a length of each semantic unit of multimedia data, which is a smallest unit for searching for multimedia data, (b) extracting a keyword from each semantic unit of the multimedia data, and (c) storing keywords together with their corresponding semantic unit's location information.

According to another aspect of the present invention, there is provided a system for constructing a multimedia database. The system includes a multimedia database which stores multimedia data, a keyword database which stores keywords necessary for searching for the multimedia data and location information of each semantic unit, which is a smallest unit for searching for multimedia data, a keyword extraction unit which extracts keywords from the multimedia data using a predetermined method, and a control unit which divides the multimedia data into semantic units having a predetermined length and stores the extracted keywords together with their corresponding semantic unit's location information.

According to another aspect of the present invention, there is provided a method for providing a multimedia data search service using a search system including a multimedia database which stores multimedia data and a keyword database which stores keywords necessary for searching for the multimedia data and location information of each semantic unit, which is a smallest unit for searching for multimedia data. The method includes inputting a keyword for searching for multimedia data, (b) searching for a semantic unit of a selected search unit level having the same keyword as the input keyword, and (c) linking resulting search results to their locations in the multimedia database and presenting the search results to a user.

According to another aspect of the present invention, there is provided a system for providing a multimedia data search service. The system includes a multimedia database which stores multimedia data, a keyword database which stores keywords necessary for searching for the multimedia data and location information of each semantic unit, which is a smallest unit for searching for multimedia data, an input unit which receives a keyword from a user, a control unit which searches the keyword database for a keyword that matches the received keyword and outputs resulting search results with links to their locations in the multimedia database, and a display unit which displays the searched results obtained by the control unit.

According to another aspect of the present invention, there is provided a method of constructing a multimedia database. The method includes (a) a user accessing a system, (b) allowing the user to designate address information of a multimedia data file desired to be executed by the user, (c) executing the multimedia data file by accessing a server where the multimedia data file is stored according to the designated address information, (d) receiving and setting a start time and an end time of each first semantic unit of the multimedia data file, which is a smallest unit for searching for multimedia data while executing the multimedia data file, and receiving representative information of each first semantic unit, and (e) storing the representative information of each first semantic unit together with the start time and end time of each first semantic unit and the address information of the multimedia data file.

According to another aspect of the present invention, there is provided a system for constructing a multimedia database. The system includes an input and output unit which allows a user to access a system, receives address information of a multimedia data file to be executed by the user, a start time and an end time of each first semantic unit of the multimedia data file, and representative information of each first semantic unit and allows the user to transmit data to or receive data from the server where the multimedia data file is stored, a keyword database which stores the representative information of each first semantic unit with the start time and end time of each first semantic unit and the address information of the multimedia data file, and a control unit which executes the multimedia data file by accessing the server where the multimedia data file is stored in response to an input from the user using the input and output unit, receives the start time and end time and the representative information of each first semantic unit in response to the input from the user and stores the received information in the keyword database together with the address information of the multimedia data file, and executes a predetermined first semantic unit of the multimedia data file using the address information of the multimedia data file and the start time and end time of the predetermined first semantic unit when a request for searching for and reproducing the predetermined first semantic unit is issued by the user.

According to another aspect of the present invention, there is provided a method of purchasing multimedia content from a multimedia content owner using a predetermined purchasing system. The method includes (a) informing a user of purchasable multimedia contents and allowing the user to select multimedia content to be purchased, (b) executing the selected multimedia content using address information of the multimedia content stored in the purchasing system, (c) allowing the user to set a start time and an end time of each first semantic unit of the multimedia content, which is a smallest unit for purchasing the multimedia content, while executing the multimedia content, (d) storing the start time and end time of each first semantic unit of the multimedia content with the address information of the multimedia content, (e) calculating a rate for a first semantic unit according to predetermined standards, and (f) generating an execution file capable of executing a first semantic unit of the multimedia content purchased by the user using the start time and end time of the first semantic unit and the address information of the multimedia content stored in the purchasing system and providing information to which the execution file is linked.

According to another aspect of the present invention, there is provided a system for purchasing multimedia content from a multimedia content owner using a predetermined purchasing system. The system includes an input and output unit which allows a user to select multimedia content including a first semantic unit to be purchased and to set a start time and an end time of the first semantic unit, a keyword database which stores the start time and end time of the first semantic unit together with address information of multimedia contents that can be purchased using the purchasing system, a controller which executes the selected multimedia content using the address information stored in the keyword database, stores the start time and end time of the first semantic unit in the keyword database in response to an input from the user using the input and output unit, generates an execution file for executing the first semantic unit using the address information of the selected multimedia content and the start time and end time of the first semantic unit, and provides link information to which the execution file is linked, and a rate calculation unit which calculates a rate for the first semantic unit according to predetermined standards.

According to another aspect of the present invention, there is provided a computer-readable recording medium on which a program enabling any of the above-described methods is recorded.

### BRIEF DESCRIPTION OF THE DRAWINGS

FIG. 1 is a schematic diagram illustrating the basic concepts of the present invention;

FIG. 2 is a flowchart of a method of constructing a multimedia database according to a preferred embodiment of the present invention;

FIG. 3 is a block diagram of a system for constructing a multimedia database according to a preferred embodiment of the present invention;

FIG. 4 is a flowchart of a method of constructing a multimedia database according to another preferred embodiment of the present invention;

FIG. 5 is a block diagram of a system for constructing a multimedia database according to another preferred embodiment of the present invention;

FIG. 6 is a flowchart of a method of providing a multimedia data search service according to a preferred embodiment of the present invention;

FIG. 7 is a block diagram of a system for providing a multimedia data search service for providing a multimedia data search according to a preferred embodiment of the present invention;

FIG. 8 is a diagram illustrating a search window according to a preferred embodiment of the present invention;

FIGS. 9A through 9C are diagrams illustrating examples of multimedia data divided into semantic units according to a preferred embodiment of the present invention;

FIG. 10 is a block diagram of a system for constructing a multimedia database through the Internet according to a preferred embodiment of the present invention;

FIG. 11 is a flowchart of a method of constructing a multimedia database through the Internet according to a preferred embodiment of the present invention;

FIG. 12 is a block diagram of a system for purchasing multimedia content through the Internet according to a preferred embodiment of the present invention; and

FIG. 13 is a flowchart of a method of purchasing multimedia content through the Internet according to a preferred embodiment of the present invention.

### BEST MODE FOR CARRYING OUT THE INVENTION

Hereinafter, the present invention will be described in greater detail with reference to the accompanying drawings in which preferred embodiments of the present invention are shown.

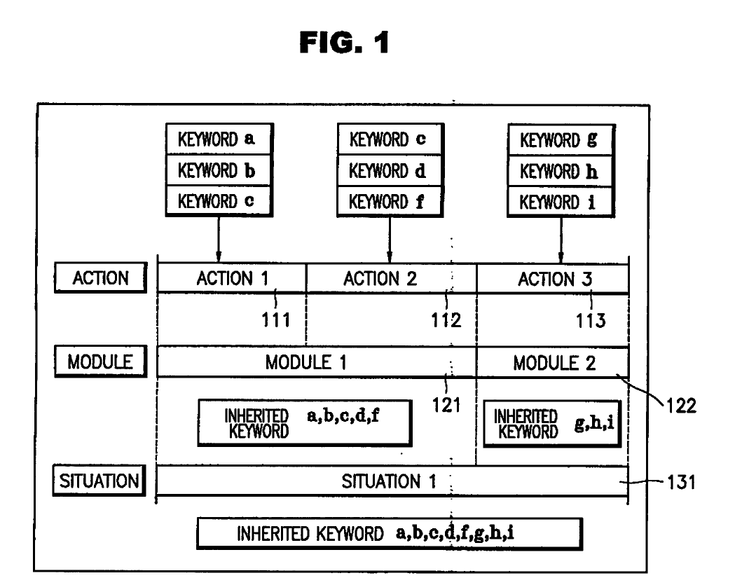

FIG. 1 is a schematic diagram illustrating the basic concepts of the present invention. The present invention is characterized by dividing multimedia data into predetermined semantic units and allotting an appropriate keyword to each semantic unit. In addition, the present invention is capable of presenting exactly what a user wants to search for as a search result.

In FIG. 1, an action (111, 112, or 113), a module (121 or 122), and a situation (131) represent a smallest unit, a semantic unit including at least one action, and a semantic unit including at least one module, respectively.

In particular, FIG. 1 illustrates a bitstream of a moving image. The bitstream is temporally divided into (marked off at predetermined intervals into) an action 1 (111), an action 2 (112), and an action 3 (113). The actions 1 through 3 (111 through 113) are associated with their respective keywords.

Modules 121 and 122 are semantic units which are at least as long as one action. The modules 121 and 122 directly inherit keywords from their corresponding actions. For example, as shown in FIG. 1, the action 1 (111) has keywords a, b, and c, and the action 2 (112) has keywords c, d, and f. Accordingly, the module 1 (121), including the action 1 (111) and the action 2 (112), directly inherits the keywords a, b, c, d, and f.

A situation 131 is a semantic unit, which is at least as long as one module. The situation 131 inherits keywords from its corresponding modules, i.e., the modules 121 and 122.

A start point and an end point of each action, each module, and each situation may be arbitrarily set by a database constructor who inputs keywords or may be automatically set and renewed at intervals of a predetermined amount of time.

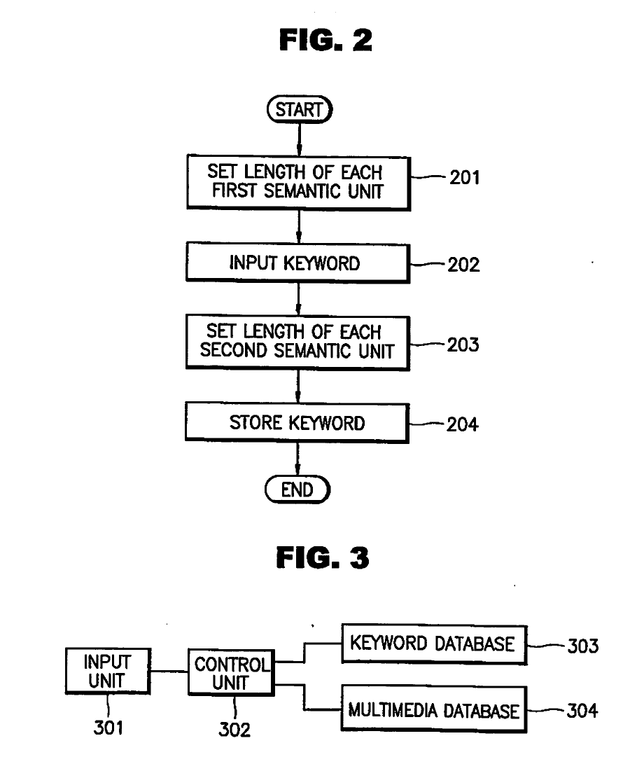

A method of constructing the multimedia database shown in FIG. 1 will be described in greater detail in the following paragraphs. FIG. 2 is a flowchart of a method of constructing a multimedia database according to a preferred embodiment of the present invention, and FIG. 3 is a block diagram of a system for constructing a multimedia database according to a preferred embodiment of the present invention. Steps of the method for constructing a multimedia database shown in FIG. 2 may be arranged in a different order other than the one shown in FIG. 2.

Referring to FIG. 3, the system for constructing a multimedia database includes a multimedia database 304 which stores multimedia data, a keyword database 303 which stores keywords necessary for searching for the multimedia data, an input unit 301 which receives keywords, and a control unit 302 which controls an entire process of constructing a multimedia database.

By using the input unit 301, a multimedia database constructor (hereinafter, referred to as the constructor) inputs location information of each first semantic unit (for example, each action), which is a smallest unit for searching for multimedia data, in step 201. Here, the location information of each first semantic unit indicates information on where a start point and an end point of each first semantic unit of multimedia data are located in the multimedia database 304.

Here, first semantic units, i.e., actions, may be continuously or discontinuously arranged. In other words, an action does not need to begin where its previous one ends. Therefore, the constructor may extract only desired portions from the multimedia data and then set the extracted portions as first semantic units, i.e., actions.

When the start point and end point of each first semantic unit of the multimedia data are input, the control unit 302 extracts location information of each first semantic unit from the multimedia database 304. ASF files (*.asf) are generally used because they can provide a function of extracting location information in a multimedia file from a marked point. However, other files can serve the same function as the ASF files with the help of predetermined programs, and thus there is no restriction imposed on the types of files that can be used in the present invention.

The constructor inputs one keyword or more for each of the first semantic units in step 202. Here, one or more keywords may be allotted to each of the first semantic units. The constructor may manually input the keyword(s) by directly typing in the keyword(s) or using a speech recognition technique where speech can be recognized as text.

Alternatively, the constructor may set in advance a variety of pieces of information, such as images, voice, and text, as keywords. Then, the ones that match the preset information in the multimedia data are automatically extracted as keywords.

In the case of moving picture data or voice, speech can be extracted and transformed into text data using a speech recognition technique, and then only predetermined parts of the extracted speech, such as nouns or pronouns, can be extracted as keywords. A method of extracting predetermined functional parts of speech using a speech recognition technique and a database including a dictionary is well known to the one skilled in the art, and thus its description will be omitted.

The controller 302 stores the input keyword(s) in the keyword database 303 along with its (their) corresponding first semantic units location information in the multimedia database 304.

Before storing keywords in the keyword database 303, the keywords may be classified into several categories depending on what they concern, such as people, objects, places, or moments of time. Then, keywords belonging to one category are stored in the keyword database 303 separately from the ones belonging to another category. Thus, the keywords stored in the keyword database 303 can be presented to a user on a category-by-category basis. For example, a series of keywords only concerning places can be presented to the user at the same time, and thus the user can easily and conveniently figure out places where a predetermined moving picture corresponding to the presented keywords has been taken based upon the presented keywords.

Preferably, the constructor may give a title to each of the first semantic units of the multimedia data and inputs the title of each of the first semantic units into the keyword database 303 along with its corresponding keyword(s), a process which is not shown in FIG. 2. By doing so, it is possible to exactly and conveniently figure out what each of the first semantic units is about based upon its corresponding title and keyword(s). For example, supposing that a user types in words ‘Jesus’ and ‘cross’ as keywords for the purpose of searching a movie title concerning a biblical story for a predetermined scene showing Jesus nailed upon the Cross, a plurality of semantic units showing a variety of scenes, such as a scene showing Jesus climbing up a hill at Golgotha with the Cross on the back, are simultaneously popped out as search results. At this time, if the plurality of semantic units are presented to a user with their corresponding title, the user can easily identify the one that he or she desires to search for from among the plurality of semantic units.

Keywords are preferably stored in the keyword database 303 so that keywords having similar meanings or indicating the same thing can be associated with one another. For example, let us assume that ‘Jesus’, ‘the son of the God’, and ‘the Messiah’ are designated as keywords of semantic units 1 through 3, respectively. Even though the semantic units 1 through 3 seemingly have different keywords, their keywords indicate the same thing, and thus when a user types in ‘Jesus’ rather than ‘the son of the God’ or ‘the Messiah’, the semantic units 1 through 3 corresponding to all the three keywords can be searched for as search results.

Here, in order to store keywords with their associated keywords in the keyword database 303, the constructor may set keywords that need to be associated before or after inputting a variety of keywords for every semantic unit of predetermined multimedia data. Thus, keywords having similar meanings or indicating the same thing can be stored together in the keyword database 303 by the control unit 302. Alternatively, a similar keyword database where keywords having similar meanings or indicating the same thing are stored together may be additionally provided, and then when a keyword is input and the one that exactly matches the input keyword exists among the keywords stored in the similar keyword database, the input keyword and its similar keywords are stored together in the keyword database 303.

A multimedia database can be completed by only performing steps 201 and 202 that have been described so far. However, in the present invention, it is preferable that the constructor inputs information on a start point and an end point of each second semantic unit including at least one first semantic unit in step 203.

Let us assume that multimedia data is searched on a first semantic unit basis and that the keyword database 303 only stores information on where in the multimedia database 304 the start point of each first semantic unit of the multimedia data is stored. In this case, the user may not be able to figure out exactly where each first semantic unit obtained as a search result ends and which portion of each first semantic unit corresponds to the keyword that he/she has input. Thus, the user may have no other options but to execute the entire file including the searched first semantic units to find data that he/she really wants.

In order to prevent such inconvenience, the keyword database 303 stores information on where in the multimedia database 304 both the start point and end point of each of the first semantic units of the multimedia data are stored so that each search result can be executed on a first semantic unit-by-first semantic unit basis, which is preferable for quick search.

In some cases, the user may not be able to figure out whether or not the search results are what he or she desires to search for because the running time of each of the search results executed on a first semantic unit-by-first semantic unit basis is too short. Therefore, the multimedia data is preferably marked off into second semantic units each of which includes at least one first semantic unit and thus is longer than a first semantic unit, and information on where in the multimedia database 304 the start point and end point of each of the second semantic units are stored is stored in the keyword database 303.

Alternatively, it is possible to allow the user to appreciate sufficiently long search results by marking off the multimedia data into third semantic units, each of which includes at least one second semantic unit and information on where in the multimedia database 304 the start point and end point of each of the third semantic units are stored in the keyword database 303.

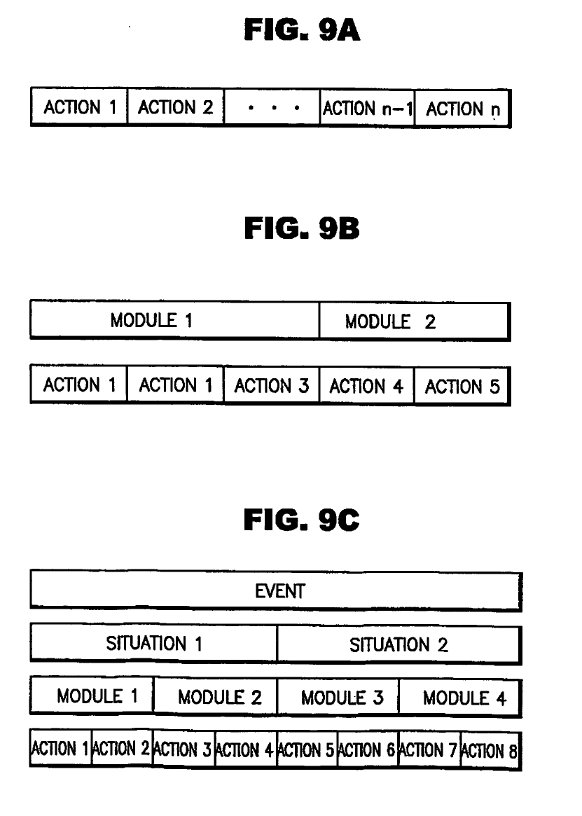

As described above, the multimedia data may be divided into actions, modules, or situations, which is shown in FIGS. 9A through 9C. Then, information on where in the multimedia database 304 the start point and end point of the action, the module, or the situation corresponding to the predetermined keyword are stored is stored in the keyword database 303.

Since a second semantic unit inherits a keyword or keywords of its corresponding first semantic unit(s), there is no need to newly input a keyword or keywords for the second semantic unit. However, it is preferable to give a title to each second semantic unit.

A keyword and information on where in the multimedia database 304 the start point and end point of a semantic unit corresponding to the keyword are stored are stored in the keyword database 303 via the controller 302. First, let us assume that the multimedia is marked off into first semantic units and into second semantic units. In this case, keywords input by the constructor are stored in the keyword database 303, and then location information of each of the first and second semantic units, i.e., information on where in the multimedia database 304 the start point and end point of each of the first and second semantic units are stored, is stored in the keyword database 303 so that the keywords and their corresponding first and second semantic units' location information can be stored together. Furthermore, a title of each of the first and second semantic units, a category of each of the keywords, and location information of multimedia content including the first and second semantic units are also stored in the keyword database 303. In a case where the multimedia content is a moving picture or voice, its start point and end point are stored with its corresponding keyword. However, in a case where the multimedia content is an image, there is no need to store the start point and end point of the image.

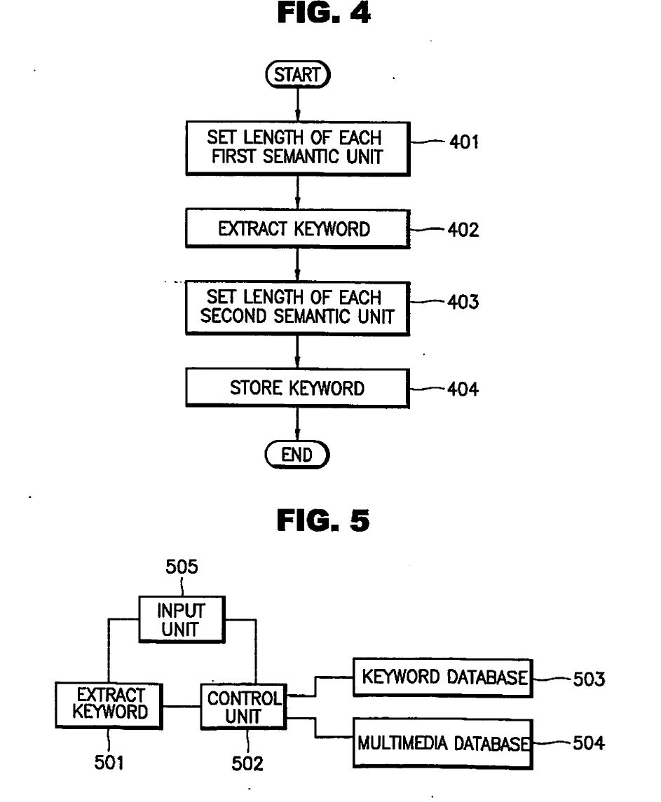

The method and the system for constructing a multimedia database according to a preferred embodiment of the present invention where a constructor is required to determine the length of each semantic unit and input keywords for each semantic unit have been described so far with reference to FIGS. 2 and 3. However, without directly inputting such information and keywords, a multimedia database can be established with the help of a predetermined program, which will be described in greater detail in the following paragraphs with reference to FIGS. 4 and 5. FIG. 4 is a flowchart of a method of constructing a multimedia database according to another preferred embodiment of the present invention, and FIG. 5 is a block diagram of a system for constructing a multimedia database according to another preferred embodiment of the present invention. The sequence of steps of the method of constructing a multimedia database shown in FIG. 4 is not limited to the one set forth herein.

Referring to FIG. 5, the system for constructing a multimedia database includes a multimedia database 504 where multimedia data is stored, a keyword database 503 where keywords necessary for searching for the multimedia data are stored, an input unit 505 which receives the length of each semantic unit of the multimedia data and the keywords, a keyword extraction unit 501 which extracts the keyword from the multimedia data, and a control unit 502 which controls an entire process of constructing a multimedia database.

A constructor sets the length of each first semantic unit and the length of each second semantic unit in steps 401 and 403. Here, a first semantic unit is a smallest unit for searching for multimedia data. The control unit 502 marks off the multimedia data at intervals of a predetermined distance in consideration of the lengths set in steps 401 and 403 and extracts information on where in the multimedia database 504 marked portions of the multimedia data are stored. In a case where the constructor has not input any information on the length of each first semantic unit and the length of each second semantic unit, each first semantic unit and each second semantic unit are set to have a predetermined length using reference length values stored in a program.

In step 402, the keyword extraction unit 501 extracts a keyword from each first semantic unit using a predetermined method.

Various methods can be used to extract keywords from data. As described above with reference to FIGS. 2 and 3, in the case of a moving image or voice, speech can be extracted and transformed into text data using a speech recognition technique, and then only predetermined parts of the extracted speech, such as nouns or pronouns, can be extracted as keywords.

Alternatively, the constructor may input in advance keyword information that can be used as keywords for semantic units of predetermined multimedia data, such as images, voices, and text, into the keyword extraction unit 601 via the input unit 505 and then allots a predetermined keyword to semantic units of the corresponding multimedia data containing the same information as the keyword information. For example, let us assume that the constructor sets the voice and images of Jesus into the keyword extractor 501 as keyword information for a movie title about biblical stories so that a predetermined keyword “Jesus” can be given to any semantic units of the movie title containing the voice or images of Jesus. Then, the keyword extraction unit 501 extracts the keyword “Jesus” from all the semantic units of the movie title where Jesus appears, and the control unit 502 stores the keyword “Jesus” in the keyword database 503 together with its corresponding semantic unit's location information in the multimedia database 504, i.e., information where in the multimedia database 504 the corresponding semantic unit is stored.

As described above with reference to FIGS. 2 and 3, keywords are stored together in the keyword database 503 so that when there is a request for search for multimedia data corresponding to any of associated keywords having similar meanings, all multimedia data corresponding to all the associated keywords are searched for in response to the search request.

In order to store keywords with their associated keywords in the keyword database 503, the constructor may set in advance predetermined keywords that need to be associated before or after inputting keywords that can represent predetermined multimedia data into the keyword database 503. Alternatively, a similar keyword database where similar keywords are stored may be additionally provided. So, when a keyword that matches any of the keywords stored in the similar keyword database is input by the constructor, its similar keywords stored in the similar keyword database are automatically stored in the keyword database 303 together.

Step 404 where keywords are stored in the keyword database 503 is the same as step 204 described above with reference to FIGS. 2 and 3, and thus its description will be omitted.

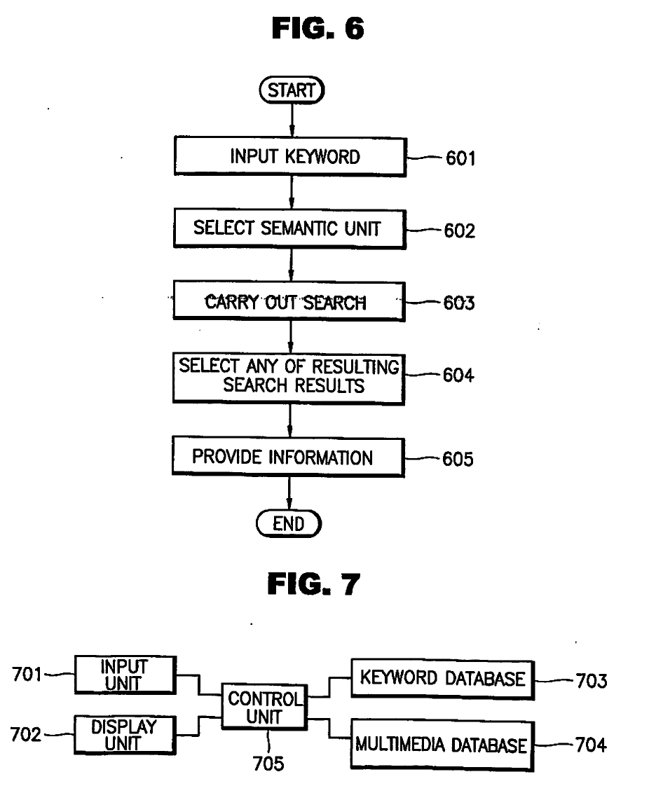

FIG. 6 is a flowchart of a search service providing method according to a preferred embodiment of the present invention, and FIG. 7 is a block diagram of a search service providing system according to a preferred embodiment of the present invention.

Referring to FIG. 7, the multimedia data search service providing system includes a multimedia database 704 where multimedia data is stored, a keyword database 703 where keywords necessary for searching for multimedia data are stored, an input unit 701 which allows a user to select semantic units or input keywords, a screen display unit 702 which displays search results, and a control unit 705 which controls the entire process of providing a multimedia data search service.

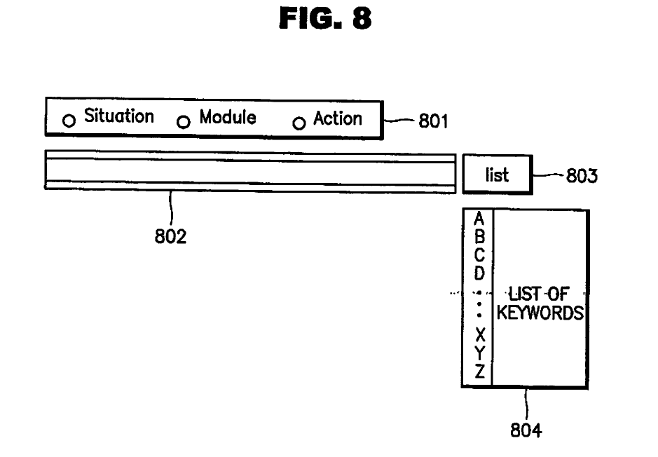

FIG. 8 is a diagram illustrating a search window for inputting keywords necessary for searching for multimedia data. As shown in a semantic unit selection window 801 of FIG. 8, three different levels of semantic units, i.e., a situation, a module, and an action, can be selected so that multimedia data can be searched for on a situation-by-situation, module-by-module, or action-by-action basis.

A user inputs a keyword to be searched for into a keyword input window 802 in step 601. The user may directly type in the keyword or select one of keywords put on a keyword list 804 by clicking a list button 803 next to the keyword input window 802.

In step 602, the user selects the amount by which each search result will be presented to the user, i.e., a semantic unit of each search result, among the three levels of semantic units provided in the semantic unit selection window 801.

Thereafter, a search for multimedia data corresponding to the input keyword is carried out in step 603. The control unit 705 searches the keyword database 703 for the one that matches the input keyword and displays search results, i.e., multimedia data corresponding to the input keyword, and their location information in the multimedia database 704 using the screen display unit 702.

In a case where each semantic unit of multimedia data is stored in the multimedia data 704 with its title, the controller 705 displays the search results and their respective titles on a screen and creates a link between each of the titles and its corresponding location information in the multimedia database 704 so that each of the search results can be reproduced from the multimedia database 704 when the user dicks its title on the screen. In a case where the multimedia data is stored in the multimedia database 704 without titles, the control unit 705 displays all keywords corresponding to each of the search results so as to help the user figure out the content of each of the search results.

The user selects one of the search results in step 604. Then, the controller 705 finds the location of the selected search result in the multimedia database 704 and reproduces the selected search result from the multimedia database 704 in step 605.

The present invention can be applied to multimedia data stored in an external server through the Internet as well as multimedia database stored in a single independent system like the embodiments set forth herein.

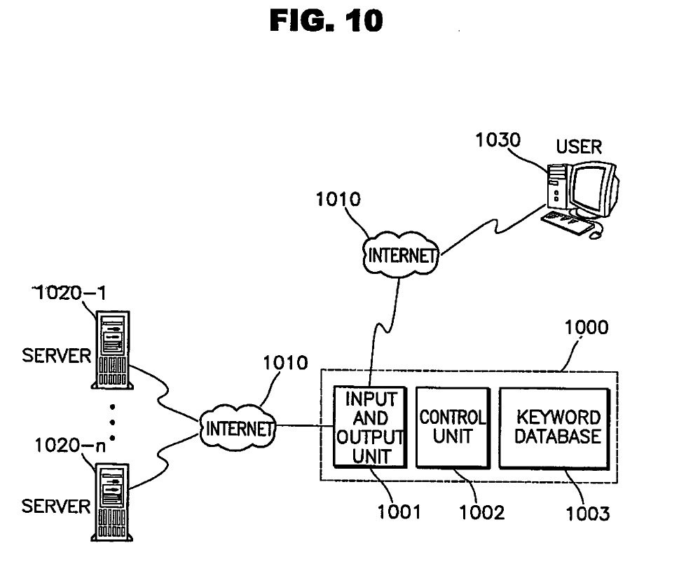

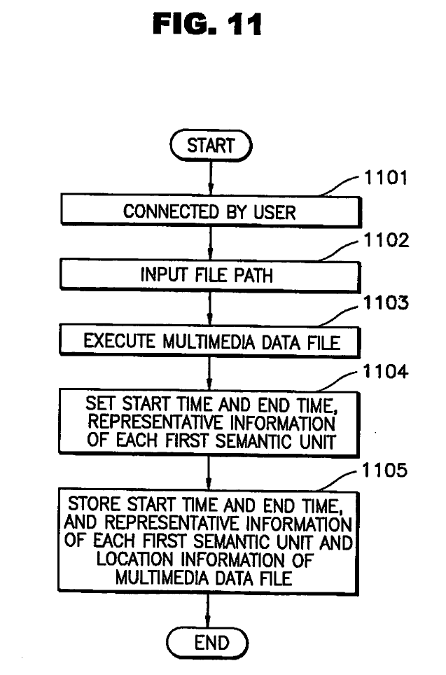

FIG. 10 is a block diagram of an Internet-based system for constructing a multimedia database according to a preferred embodiment of the present invention, and FIG. 11 is a flowchart of an Internet-based method of constructing a multimedia database according to a preferred embodiment of the present invention.

Referring to FIG. 10, an Internet-based system for constructing a multimedia database 1000 includes an input and output unit 1001, a control unit 1002, and a keyword database 1003 rather than a multimedia database.

The input and output unit 1001 receives data from and transmits data to a user 1030 and a server 1020 where multimedia data files are stored by being connected to the user 1030 and the server 1020 through the Internet 1010.

In the keyword database 1003, location information of multimedia files indexed by the user 1030 and other representative information, such as start and end points and keywords of each semantic unit, are stored.

The control unit 1002 accesses the server 1020 where multimedia data files are stored in response to a request input by the user 1030 through the input and output unit 1001, and executes multimedia data files stored in the server 1020, receives start time information and end time information and representative information of each semantic unit corresponding to the input keywords and stores the received information in the keyword database 1003. When the user 1030 wants a searched semantic unit of a multimedia data file to be reproduced, the control unit 1002 controls a multimedia player for the multimedia data file to reproduce only the searched semantic unit of the multimedia data file by using the start time information and the end time information of the searched semantic unit and location information of the multimedia data file in the keyword database 1030.

The present embodiment will be described in greater detail in the following paragraphs.

The user 1030 accesses a web page provided by the Internet-based system for constructing a multimedia database 1000 in step 1101.

User identification, such as log-in, is performed, and then the user 1030 designates a path of a multimedia data file to be indexed in step 1102. The multimedia data file may be a file stored in a database provided in the system of the present invention, as shown in FIGS. 3, 5, and 7, or a file stored in the server 1020 that can be accessed through the Internet 1010.

For example, in a case where multimedia data that the user 1030 wants to index is scenes broadcasted on TV, multimedia data files can be stored in a server operating a web page of a broadcasting system.

The user 1030 may designate such path by inputting the Internet address of a place where the multimedia data file is stored.

Then, the control unit 1002 accesses a predetermined server according to the designated path and executes the multimedia data file stored in the server.

While watching reproduced multimedia data, the user 1030 sets first semantic units, as described above with reference to FIG. 2, and inputs a keyword and a title for each first semantic unit in step 1104. A process of setting a start point and an end point of each first semantic unit may be performed before or after a process of inputting a keyword for each first semantic unit.

After the setting of the first semantic unit, the control unit 1002 stores location information of the reproduced multimedia data and information on a start point and an end point of each first semantic unit of the reproduced multimedia data in the keyword database in step 1105.

A process of searching for and executing a desired portion of the multimedia data using a multimedia database is the same as the one shown in FIG. 6 except for several differences therebetween, which are as follows.

First of all, in FIG. 10, the user 1030 transmits data to and receives data from external servers by accessing the Internet-based system for constructing a multimedia database 1000 of the present invention through the Internet. Second, in FIG. 10, a multimedia database is connected to the Internet-based system for constructing a multimedia database 1000 through the Internet. Third, in FIG. 10, an external server that stores a multimedia data file selected by the user 1030 is accessed according to a path stored in the keyword database 1003 when the user 1030 desires a search result to be reproduced. Fourth, only a predetermined semantic unit corresponding to a keyword selected by the user 1030 is presented to the user 1030 using the start point and end point of the predetermined semantic unit.

The Internet-based method of constructing a multimedia database of the present invention makes it possible to create a link between a multimedia data file containing multimedia content and a web page so that only a predetermined portion of the multimedia content can be executed by using the link provided on the web page. In addition, the Internet-based method of constructing a multimedia database of the present invention makes it possible to sell a specific portion of multimedia content contained in a multimedia data file.

For example, let us assume that a newspaper company is attempting to provide a news report concerning a predetermined event together with moving pictures concerning the predetermined event broadcasted on TV via its web page. In the prior art, the newspaper company has to purchase a file containing a news program for the day of the predetermined event, decode the purchased file, extract data desired to be reproduced from the decoded file, encode the extracted data into a file, and creating a link between the file and the web page so that the file can be executed using the link. This method, however, is very inconvenient and thus has not been adopted very often to execute only a portion of specific multimedia content.

On the other hand, the Internet-based system for constructing a multimedia database and method make it possible to obtain the same effect as the above-described conventional method with even more simplified processes.

Hereinafter, a method and a system for creating a link between a web page and a predetermined portion of multimedia content contained in a multimedia data file using a multimedia content purchasing system according to a preferred embodiment of the present invention will be described in greater detail. A process of dividing multimedia data into first semantic units or second semantic units has already been described above, and thus its description will be omitted. In the following description, only a case where multimedia data is divided into first semantic units will be focused on.

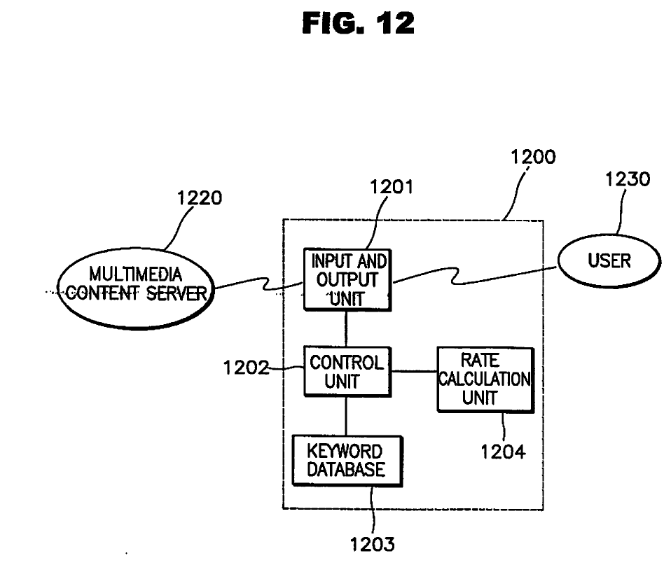

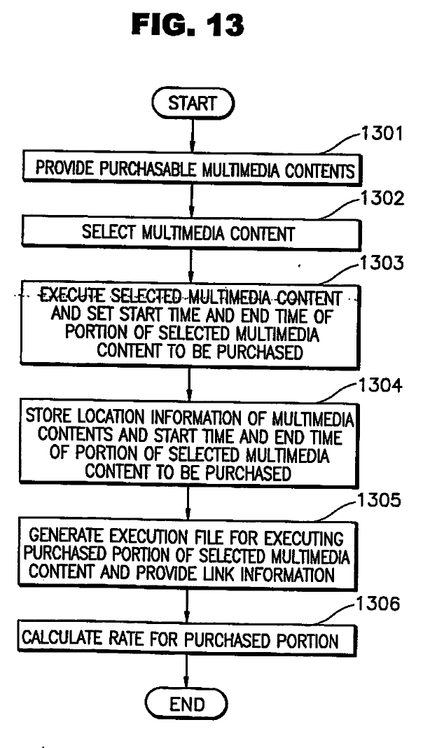

FIG. 12 is a block diagram of a system for purchasing multimedia content through the Internet according to a preferred embodiment of the present invention, and FIG. 13 is a flowchart of a method of purchasing multimedia content through the Internet according to a preferred embodiment of the present invention.

The multimedia content purchasing system according to a preferred embodiment of the present invention may be located in a server 1220 of a multimedia content owner, a server of a multimedia content purchaser 1230, or a server of another business person. If there are a plurality of people who are willing to buy multimedia content, they are provided with multimedia content via different multimedia purchasing systems. Preferably, each multimedia purchasing system can be used after being authorized by its owner.

The multimedia content purchasing system according to a preferred embodiment of the present invention includes an input and output unit 1201, a control unit 1202, a keyword database 1203, and a rate calculation unit 1204.

In the keyword database 1203, location information of multimedia data files provided by a multimedia content owner is stored. Addresses of multimedia data files stored in the keyword database 1203 are preferably encrypted so that they cannot be interpreted by purchasers or other users. By doing so, multimedia content can be prevented from being illicitly accessed or linked.

When a purchaser accesses the multimedia content purchasing system or drives the multimedia content purchasing system in his or her server, the control unit 1202 presents a list of multimedia contents that can be purchased, among multimedia contents registered in the keyword database 1203, in step 1301. Then, in step 1302, the purchaser selects multimedia content to be purchased.

In step 1303, the control unit 1202 accesses a server where the selected multimedia content is stored according to path information of the selected multimedia content, draws the selected multimedia content from the corresponding server, and executes the drawn multimedia data. For executing the multimedia data, a multimedia player may be further included in the multimedia content purchasing system, or a multimedia player possessed by the purchaser may be used.

In step 1304, the control unit 1202 receives representative information of a semantic unit desired by the purchaser, such as keywords, and a title of the semantic unit, a start time and an end time and stores the representative information in the keyword database 1203. If the purchaser aims at purchasing only a portion of multimedia content, there is no need for the control unit 1202 to receive the representative information including keywords for the corresponding semantic unit. However, in order for the purchaser to purchase a plurality of semantic units for the multimedia content and in order for a visitor to a home page of the purchaser to search the purchased semantic units, the representative information needs to be input into the control unit 1202. A process of inputting the representative information into the control unit 1202 has been described above more than one time, and thus its description will be omitted.

In step 1305, the control unit 1202 outputs execution information necessary to execute the semantic unit selected by the purchaser so that the user can create a link between the corresponding semantic unit and his or her own web page in step 1305.

Here, the execution information includes address information of the multimedia content purchasing system, address information of multimedia content including the semantic unit selected by the purchaser, and the start point and end point of the selected semantic unit.

In addition, the execution information is preferably stored in an encrypted execution file format so that other users cannot interpret the address information of the multimedia data.

When a visitor to the web site of the purchaser selects the linked execution information, the multimedia content purchasing system starts to operate. Then, the multimedia content purchasing system accesses the server where the multimedia content is stored and reproduces the semantic unit selected and purchased by the purchaser.

In order to watch the semantic unit purchased by the purchaser, the visitor must use the multimedia content purchasing system. Therefore, the present invention makes it possible to charge the purchaser for the purchased semantic unit based on the number of times the purchased semantic unit is reproduced.

The multimedia content owner can charge the purchaser for the purchased semantic unit in various ways through a mutual contract. For example, the multimedia content owner can charge the purchaser based on the amount of multimedia data purchased by the purchaser, the number of times the purchased multimedia data is reproduced, or a period of time during which the purchased multimedia data is serviced.

In the rate calculation unit 1204, a rate calculation method is set according to the mutual contract between the multimedia content owner and the purchaser, and rates are calculated according to the rate calculation method in step 1306. It is preferable to let both the multimedia content owner and the purchaser know about the calculated rates.

The present invention can be realized as computer-readable codes written on a computer-readable recording medium. Here, the computer-readable recording medium includes any kind of recording medium which can be read by a computer system. For example, the computer-readable recording medium includes a ROM, a RAM, a CD-ROM, a magnetic tape, a floppy disk, an optical data storage, and a carrier wave (data transmission through the internet). The computer-readable recording medium can be decentralized to computer systems connected over network, and a computer can read the recording medium in a decentralized way.

### Industrial Applicability

As described above, the system for constructing a multimedia database and method according to the present invention and the multimedia database search service system and method according to the present invention make it possible for a user to quickly search for multimedia data that he or she wants and watch only necessary portions of the multimedia data.

In addition, the system for constructing a multimedia database and method according to the present invention and the multimedia database search service system and method according to the present invention will enable easy trades for moving pictures through the internet and contribute to activation of the moving image market.

1. A method of constructing a multimedia database method, comprising:
(a) receiving a start point and an end point of each first semantic unit of multimedia data, which is a smallest unit for searching for multimedia data;
(b) receiving a keyword for each first semantic unit;
(c) receiving a start point and an end point of each second semantic unit of the multimedia data including at least one first semantic unit; and
(d) storing a keyword together with location information of its corresponding first semantic unit and second semantic unit.

2. The method of claim 1 further comprising (e) receiving a start point and an end point of each third semantic unit including a predetermined number of second semantic units,
wherein In (d), a keyword is stored with location information of its corresponding third semantic unit.

3. The method of claim 1 further comprising (f) receiving titles of each first semantic unit and each second semantic unit,
wherein in (d), a keyword is stored with the tides of its corresponding first semantic unit and second semantic unit.

4. The method of claim 1, wherein a keyword is classified into one of predetermined categories and is stored together with its corresponding category in (d).

5. The method of claim 1 or 4, wherein a keyword is classified into a person category, an object category, a time category, or a place category.

6. The method of claim 1 further comprising (g) storing a predetermined keyword together with its similar keywords so that a semantic unit corresponding to the predetermined keyword and semantic units corresponding to its similar keywords can be searched for together when a search for the semantic unit corresponding to the predetermined keyword or any of its similar keywords is carried out.

7. The method of claim 1, wherein the length of each first semantic unit and the length of each second semantic unit are determined by a user who constructs the multimedia database.

8. A system for constructing a multimedia database, comprising:
a multimedia database which stores multimedia data;
a keyword database which stores keywords necessary for searching for the multimedia data, location information of each first semantic unit of the multimedia data, which is a smallest unit for searching for multimedia data, and location information of each second semantic unit of the multimedia data, which includes at least one first semantic unit;
an input unit which receives the location information of each first semantic unit, including a start point and an end point, the location information of each second semantic unit, including a start point and an end point, and the keywords; and
a control unit which receives the location information of each first semantic unit, the location information of each second semantic unit, and the keywords from the input unit and stores the keywords in the keyword database together with their corresponding first and second semantic units' location information.

9. The system of claim 8, wherein the input unit receives titles of each first semantic unit and each second semantic unit, and the control unit stores the titles in the keyword database together with their corresponding keywords.

10. The system of claim 8, wherein the input unit receives predetermined categories into which the keywords are classified, and the controller stores the keywords with their corresponding category.

11. The system of claim 8, wherein the keyword database includes a similar keyword database where keywords having similar meanings or indicating the same thing are stored, and when a keyword is input via the input unit, the controller searches the similar keyword database for a keyword that matches the input keyword, and, if there is a search result, stores the input keyword in the keyword database together with its similar keywords obtained from the similar keyword database so that not only a semantic unit corresponding to the input keyword but also semantic units corresponding to its similar keywords can be searched for when a search for the semantic unit of the input keyword or any of its similar keywords is carried out.

12. A method of constructing a multimedia database, comprising:
(a) setting a length of each first semantic unit of multimedia data, which is a smallest unit for searching for multimedia data according to a user's input;
(b) extracting a keyword from each first semantic unit using a predetermined method;
(c) setting a length of each second semantic unit of the multimedia data including at least one first semantic unit according to the users input; and
(d) storing the extracted keyword with its corresponding first semantic unit and second semantic unit.

13. The method of claim 12, wherein (b) comprises:
(b1) extracting voice data from the multimedia data using a predetermined speech recognition technique; and
(b2) extracting a predetermined part of speech from the extracted voice data as a keyword.

14. The method of claim 12, wherein (b) further comprises:
(b3) receiving a first keyword and first keyword information; and
(b4) extracting the first keyword as a keyword of a first semantic unit when the first semantic unit has the same keyword information as the received keyword information.

15. The method of claim 14, wherein the keyword information is voice, an image, or text.

16. A system for constructing a multimedia database, comprising:
a multimedia database which stores multimedia data;
a keyword database which stores keywords necessary for searching for the multimedia data, location information of each first semantic unit of the multimedia data, which is a smallest unit for searching for multimedia data, and location information of each second semantic unit of the multimedia data, which includes at least one first semantic unit;
a keyword extraction unit which extracts keywords from the multimedia data using a predetermined method; and
a control unit which divides the multimedia data into first semantic units and second semantic units and stores keywords in the keyword database together with their corresponding first and second semantic units' location information.

17. The system of claim 14 further comprising an input unit which receives the location information of each first semantic unit, including a start point and an end point, the location information of each second semantic unit, including a start point and an end point, and the keywords.

18. The system of claim 16, wherein the keyword extraction unit comprises:
a voice extractor which extracts voice data from the multimedia data using a predetermined speech recognition technique; and
a part-of-speech extractor which extracts a predetermined part of speech from the voice data extracted by the voice extractor as a keyword.

19. The system of claim 16 further comprising an input unit which receives a first keyword and first keyword information,
wherein the keyword extraction unit extracts the first keyword as a keyword of a first semantic unit when the first semantic unit has the same keyword information as the received keyword information.

20. A method of providing a multimedia data search service using a system for providing a multimedia data search service, including a multimedia database which stores multimedia data, and a keyword database which stores keywords necessary for searching for the multimedia data, location information of each first semantic unit of the multimedia data, which is a smallest unit for searching for multimedia data, and location information of each second semantic unit of the multimedia data, including at least one first semantic unit, the method comprising:
(a) receiving keywords necessary to search for multimedia data;
(b) allowing a user to select a search unit level from between a first semantic unit and a second semantic unit;
(c) searching for multimedia data of the received search unit level whose keywords match the received keyword; and
(d) outputting information of a searched semantic unit of the received search unit level, linking with the search semantic unit in the multimedia database.

21. The method of claim 20, wherein keywords are stored in the keyword database together with their corresponding first and second semantic units' location information and titles, and in (d), titles of searched semantic units are displayed on a screen.

22. The method of claim 20, wherein in (d), the searched semantic units are displayed on a screen together with their respective keywords.

23. A system for providing a multimedia data search service, comprising:
a multimedia database which stores multimedia database;
a keyword database which stores keywords necessary for searching for the multimedia data, location information of each first semantic unit of the multimedia data, which is a smallest unit for searching for multimedia data, and location information of each second semantic unit of the multimedia data, which includes at least one first semantic unit;
an input unit which receives a keyword and a search unit level a user;
a control unit which searches the keyword database for a keyword that matches the received keyword, provides links between resulting search results and places in the multimedia database where the search results are stored, and outputs some of the search results selected by the user; and
a display unit which displays the searched results obtained by the control unit.

24. A method of constructing a multimedia database, comprising:
(a) receiving location information of each semantic unit of multimedia data, which is a smallest unit for searching for multimedia data;
(b) receiving a keyword for each semantic unit; and
(c) storing keywords together with their corresponding semantic unit' location information.

25. A system for constructing a multimedia database, comprising:
a multimedia database which stores multimedia data;
a keyword database which stores keywords necessary for searching for the multimedia data and location information of each semantic unit, which is a smallest unit for searching for multimedia data;
an input unit which receives the location information of each semantic unit, including a start point and an end point, and the keywords; and
a control unit which receives the location information of each semantic unit from the input unit and the keywords and stores the keywords in the keyword database together with their corresponding semantic units location information.

26. A method of constructing a multimedia database, comprising:
(a) receiving a length of each semantic unit of multimedia data, which is a smallest unit for searching for multimedia data;
(b) extracting a keyword from each semantic unit of the multimedia data; and
(c) storing keywords together with their corresponding semantic unit's location information.

27. A system for constructing a multimedia database, comprising:
a multimedia database which stores multimedia data;
a keyword database which stores keywords necessary for searching for the multimedia data and location information of each semantic unit, which is a smallest unit for searching for multimedia data;
a keyword extraction unit which extracts keywords from the multimedia data using a predetermined method; and
a control unit which divides the multimedia data into semantic units having a predetermined length and stores the extracted keywords together with their corresponding semantic units location information.

28. A method for providing a multimedia data search service using a search system including a multimedia database which stores multimedia data and a keyword database which stores keywords necessary for searching for the multimedia data and location information of each semantic unit, which is a smallest unit for searching for multimedia data, the method comprising:
(a) inputting a keyword for searching for multimedia data;
(b) searching for a semantic unit of a selected search unit level having the same keyword as the input keyword; and
(c) linking resulting search results to their locations in the multimedia database and presenting the search results to a user.

29. A system for providing a multimedia data search service, comprising:
a multimedia database which stores multimedia data;
a keyword database which stores keywords necessary for searching for the multimedia data and location information of each semantic unit, which is a smallest unit for searching for multimedia data;
an input unit which receives a keyword from a user;
a control unit which searches the keyword database for a keyword that matches the received keyword and outputs resulting search results with links to their locations in the multimedia database; and
a display unit which displays the searched results obtained by the control unit.

30. A method of constructing a multimedia database, comprising:
(a) a user accessing a system;
(b) allowing the user to designate address information of a multimedia data file desired to be executed by the user;
(c) executing the multimedia data file by accessing a server where the multimedia data file is stored according to the designated address information;
(d) receiving and setting a start time and an end time of each first semantic unit of the multimedia data file, which is a smallest unit for searching for multimedia data while executing the multimedia data file, and receiving representative information of each first semantic unit; and
(e) storing the representative information of each first semantic unit together with the start time and end time of each first semantic unit and the address information of the multimedia data file.

31. A system for constructing a multimedia database, comprising:
an input and output unit which allows a user to access a system, receives address information of a multimedia data file to be executed by the user, a start time and an end time of each first semantic unit of the multimedia data file, and representative information of each first semantic unit and allows the user to transmit data to or receive data from the server where the multimedia data file is stored;
a keyword database which stores the representative information of each first semantic unit with the start time and end time of each first semantic unit and the address information of the multimedia data file; and
a control unit which executes the multimedia data file by accessing the server where the multimedia data file is stored in response to an input from the user using the input and output unit, receives the start time and end time and the representative information of each first semantic unit in response to the input from the user and stores the received information in the keyword database together with the address information of the multimedia data file, and executes a predetermined first semantic unit of the multimedia data file using the address information of the multimedia data file and the start time and end time of the predetermined first semantic unit when a request for searching for and reproducing the predetermined first semantic unit is issued by the user.

32. A method of purchasing multimedia content from a multimedia content owner using a predetermined purchasing system, the method comprising:
(a) informing a user of purchasable multimedia contents and allowing the user to select multimedia content to be purchased;
(b) executing the selected multimedia content using address information of the multimedia content stored in the purchasing system;
(c) allowing the user to set a start time and an end time of each first semantic unit of the multimedia content, which is a smallest unit for purchasing the multimedia content, while executing the multimedia content;
(d) storing the start time and end time of each first semantic unit of the multimedia content with the address information of the multimedia content;
(e) calculating a rate for a first semantic unit according to predetermined standards; and
(f) generating an execution file capable of executing a first semantic unit of the multimedia content purchased by the user using the start time and end time of the first semantic unit and the address information of the multimedia content stored in the purchasing system and providing information to which the execution file is linked.

33. A system for purchasing multimedia content from a multimedia content owner using a predetermined purchasing system, the system comprising:
an input and output unit which allows a user to select multimedia content including a first semantic unit to be purchased and to set a start time and an end time of the first semantic unit;
a keyword database which stores the start time and end time of the first semantic unit together with address information of multimedia contents that can be purchased using the purchasing system;
a controller which executes the selected multimedia content using the address information stored in the keyword database, stores the start time and end time of the first semantic unit in the keyword database in response to an input from the user using the input and output unit, generates an execution file for executing the first semantic unit using the address information of the selected multimedia content and the start time and end time of the first semantic unit, and provides link information to which the execution file is linked; and
a rate calculation unit which calculates a rate for the first semantic unit according to predetermined standards.

34. A computer-readable recording medium on which a program enabling the method of any of claims 1 through 4, 6, 7, 12 through 15, 20 through 22, 24, 26, 28, and 30 through 32 is recorded.
